(19) United States
(12) Patent Application Publication
(10) Pub. No.: US 2002/0084950 A1
(43) Pub. Date: Jul. 4, 2002

(54) Display device for use in vehicle

(75) Inventors: Kunimitsu Aoki, Shizuoka (JP); Go Nakamura, Shizuoka (JP); Tetsuya Sugiyama, Shizuoka (JP); Takanori Watanabe, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: Yazaki Corporation, Tokyo (JP)

(21) Appl. No.: 09/981,785

(22) Filed: Oct. 19, 2001

(30) Foreign Application Priority Data
Dec. 28, 2000 (JP) 2000-400951

(51) Int. Cl. G09G 5/00

(52) U.S. Cl. 345/7

(57) ABSTRACT

A display device for use in a vehicle is provided, by which an image displayed on a display unit (display source) 5 is projected on a projection area E of a windshield 3 of the vehicle so that the foreground of the vehicle visible from an eye point I of the vehicle through the windshield 3 and a virtual image S of the image projected on the windshield 3, which is superposed upon the foreground, are seen together. The display device includes a correction member 6, disposed between the windshield 3 and the display source 5, for transmitting a light of the image therethrough so as to correct the image to be projected on the windshield 3 so that distortion of the image, which is seen from the eye point I, arising from non-plane of the projection area E of the windshield 3 is canceled out. The correction member 6 is formed by extracting a specific portion, which can cancel out the distortion of the image, from a lens having a curved surface having a single radius of curvature. By using the display device, the correction of the distorted virtual image can be accurately carried out with the inexpensive correction member 6.

### BACKGROUND OF THE INVENTION

(1) Field of the Invention

The present invention relates to a display device for use in a vehicle and, more specifically, to a display device for use in a vehicle, by which an image displayed on a display source is projected on a projection area of a windshield of the vehicle so that a driver can see the foreground of the vehicle visible from an eye point of the vehicle through the windshield together with a virtual image of the image projected on the windshield, which is superposed upon the foreground.

(2) Description of the Related Art

Recently, with increase and diversification of information required by a driver during a drive, a projection-type display unit called a head up display has been adopted so that information, which cannot be displayed in a meter unit due to the lack of the space, is displayed on a windshield as a virtual image, thereby a driver can see the foreground of the vehicle through the windshield together with the virtual image, which is superposed upon the foreground.

In such a projection-type display unit, since a windshield on which an image from an image source is projected has not a plane surface, and the curvature and the angle of inclination relatively to the horizontal plane (or vertical plane) are different depending upon the position on the windshield, therefore the virtual image projected on the windshield is distorted, thereby affecting the visibility of the virtual image.

In order to solve the problem described above, the correction of distortion of the virtual image projected on a windshield has been proposed by using an optical element or by controlling the display as disclosed, for example, in Japanese Patent Application Laid-Open No. H3-113413 and No. H4-283790.

However, the correction of the distortion with reflection and refraction by using an optical element in the head up display, in which the virtual image is distorted due to non-plane of the windshield, cannot be sufficiently carried out only with determining the amount of correction in terms of the curvatures in the lateral and longitudinal directions of the windshield. That is, since the amount of the correction is different depending upon the position in a display area of the windshield on which the virtual image is projected, therefore the configuration of a curved surface of the optical element becomes complicated to carry out a sufficient correction, thereby rendering the manufacture of such an optical element to be difficult and causing a high cost thereof.

### SUMMARY OF THE INVENTION

It is therefore an objective of the present invention to solve the above problem and to provide a display device for use in a vehicle, by which the correction of the distorted virtual image can be accurately carried out with an inexpensive member for correction.

In order to attain the above objective, a first aspect of the present invention is to provide a display device for use in a vehicle, by which an image displayed on a display source is projected on a projection area of a windshield of the vehicle so that the foreground of the vehicle visible from an eye point of the vehicle through the windshield and a virtual image of the image projected on the windshield, which is superposed upon the foreground, are seen together, comprising

a correction member, disposed between the windshield and the display source, for transmitting a light of the image therethrough so as to correct the image to be projected on the windshield so that distortion of the image, which is seen from the eye point, arising from non-plane of the projection area of the windshield is canceled out,

wherein the correction member is formed by extracting a specific portion, which can cancel out the distortion of the image, from a lens having a curved surface having a single radius of curvature.

With the constitution described above, an image displayed on a display source is adjusted by the correction member while a light of the image passes therethrough and is projected on a projection area of a windshield. Since the correction member is formed by extracting a specific portion, which can cancel out the distortion of the image, from a lens having a curved surface having a single radius of curvature, therefore, even if the shape of the correction member becomes complicated because each correction with different amount thereof is required for corresponding section of the projection area, there is no need to machine the correction member according to each different amount of correction. That is, a low cost correction member extracted from an existing lens can be used to carry out an accurate correction of the virtual image. Furthermore, even if the shape of the windshield is different depending upon the type of the vehicle and thereby the amount of the correction changes, a specific portion in accordance with the amount of the correction can be extracted from an existing lens.

A second aspect of the present invention is to provide a display device for use in a vehicle, by which an image displayed on a display source is projected on a projection area of a windshield of the vehicle so that the foreground of the vehicle visible from an eye point of the vehicle through the windshield and a virtual image of the image projected on the windshield, which is superposed upon the foreground, are seen together, comprising

a correction member, disposed between the windshield and the display source, for transmitting a light of the image therethrough so as to correct the image to be projected on the windshield so that distortion of the image, which is seen from the eye point, arising from non-plane of the projection area of the windshield is canceled out,

wherein the correction member is a specific portion, which can cancel out the distortion of the image, of a lens having a curved surface having a single radius of curvature.

With the constitution described above, an image displayed on a display source is adjusted by the correction member while a light of the image passes therethrough and is projected on a projection area of a windshield. Since the correction member is a specific portion, which can cancel out the distortion of the image, of a lens having a curved surface having a single radius of curvature, even if the shape of the correction member becomes complicated because each correction with different amount thereof is required for corresponding section of the projection area, there is no need to machine the lens. That is, an existing lens can be used to carry out an accurate correction of the virtual image. Furthermore, even if the shape of the windshield is different depending upon the type of the vehicle and thereby the amount of the correction changes, one can select and use a lens having the specific portion in accordance with the amount of the correction or one can use the specific portion of a lens.

### BRIEF DESCRIPTION OF THE DRAWINGS

FIG. 1 is a cross sectional view illustrating a principle constitution of a display device for use in a vehicle according to the preferred embodiment of the present invention;

FIG. 2 is a view illustrating a windshield on which a light of an image from the display unit in FIG. 1 is irradiated and the circumference of the windshield;

FIG. 3 illustrates an image of the information from an instrument in which the image signal is generated, to be projected on the windshield in FIG. 1;

FIG. 4 illustrates an inverse virtual image supposed to be seen on the windshield when the visual image shown in FIG. 3 is displayed on the display unit;

FIG. 5 is an enlarged perspective view illustrating the display unit and the correction member shown in FIG. 1;

FIG. 6A illustrates another preferred embodiment of the correction member; and

FIG. 6B illustrates another preferred embodiment of the correction member.

### DESCRIPTION OF THE PREFERRED EMBODIMENTS

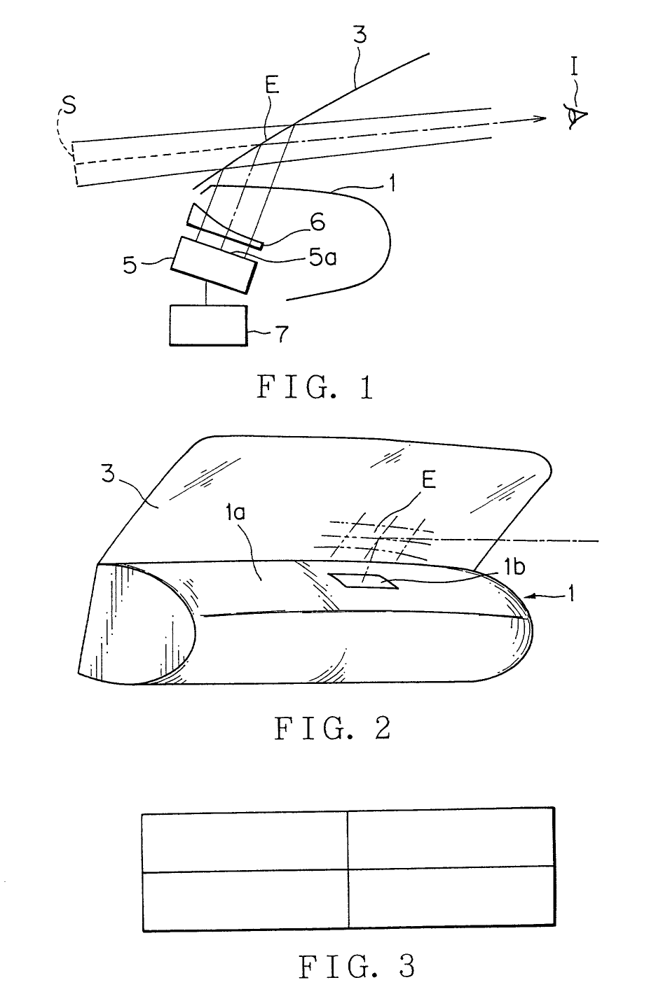

In the following, a display device for use in a vehicle according to a preferred embodiment of the present invention will be explained with reference to FIGS. 1-6.

As shown in FIG. 1, the display device for use in a vehicle includes a display unit 5 (corresponding to the display source) received in the interior of a dash-board 1 of the vehicle and a control unit 7 for controlling the content of the image displayed by the display unit 5.

The display unit 5 is, for example, a natural light device (such as a field emission display, fluorescent display tube and electroluminescence display) and liquid crystal display with backlight. The display unit 5 luminously displays an inverse image of supplementary information required for driving such as information for the direction of travel by navigation system and traveling speed on a display surface Sa arranged facing up, with arranging the upper side of the image to the rear side of the vehicle and the lower side of the image to the front side of the vehicle.

As shown in FIG. 2, a light of the inverse image displayed on the display unit 5 is projected on a projection area E of a non-flat windshield 3 arranged above the dash-board 1 passing through an opening 1b formed on an upper surface 1a of the dash-board 1, thereby the foreground seen through the windshield 3 and a virtual image S of the inverse image displayed on the display unit 5 are together seen from the eye point I of a driver of the vehicle.

Between the display surface 5a of the display unit 5 and the windshield 3, disposed is a correction member 6 for passing a light of the image to be projected on the windshield 3 therethrough and adjusting the light of the image so that the distortion of the image, which is seen from the eye point I, arising from non-plane of the projection area E of the windshield 3 is canceled out.

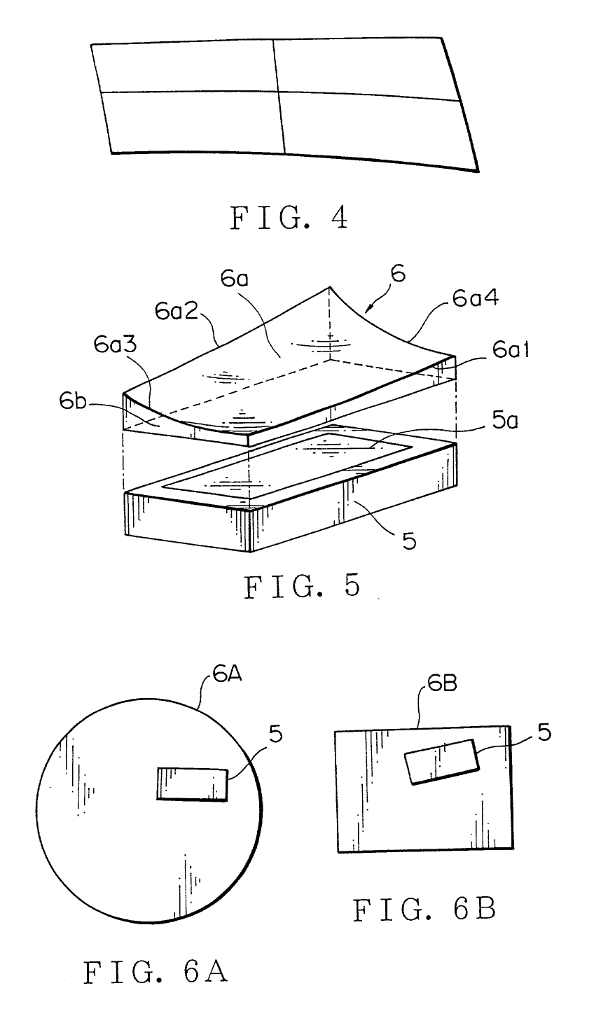

The windshield 3 is formed non-flat having each curvature with respect to the horizontal or longitudinal direction. Supposing that an image of the information from an instrument in which the image signal is generated in an information-generating unit (not shown in the figure) is a lattice-like image consisting of longitudinal and lateral lines as shown in FIG. 3, when one sees the windshield 3 in front from the eye point I, an inverse virtual image supposed to be seen on the windshield 3 is distorted as if the image is pulled in the lower right direction as shown in FIG. 4.

Therefore, since the right side of the inverse virtual image must be more intensely corrected compared to the left side thereof, the curved surface configuration of the correction member 6 is designed so as to cancel out the distortion of the inverse virtual image. A lens having thus designed curved surface configuration or similar curved surface configuration is selected from a plurality of concave lenses (hereinafter, lens), which are optical elements and, for example, cylindrical lenses and spherical lenses, having a curved surface having a single radius of curvature.

After the lens is selected, the correction member 6 is extracted from the lens to form the correction member 6 as shown in FIG. 5 so as to have the configuration corresponding to the outer configuration of the upper surface of the display unit 5. In the preferred embodiment, since the amount of the correction at lower side of the projection area E is larger than that at upper side thereof, the distance from the flat surface 6b to the curved surface 6a increases with shifting from the upper periphery 6a1 to the lower periphery 6a2, which correspond to the projection area E. Further, since the amount of the correction at right side of the projection area E is larger than that at left side thereof, the distance from the flat surface 6b to the curved surface 6a increases with shifting from the left periphery 6a3 to the right periphery 6a4, which correspond to the projection area E. That is, the correction member 6 is formed to have a curved surface 6a so that the distance from the flat surface 6b to the curved surface 6a, corresponding to the lower right of the projection area E, is larger compared to the other distances.

Thus formed correction member 6 is arranged to face the windshield 3 at the curved surface 6a and the flat surface 6b is arranged to face the display unit 5. Since the correction member 6 is formed by extracting the specific portion from the lens having a curved surface having a single radius of curvature, the curved surface 6a suitable to correct the distortion of the projection area E can be easily formed, a low cost correction member can be manufactured even if the configuration of the curved surface 6a becomes complicated.

As for the amount of the correction for every section of the lens, the amount of the correction can be computed on the basis of measured values obtained by an actual experiment of transmission of a light of the inverse image displayed on the display unit 5, or computed from the configurations of the windshield 3 and the lens by using a simulation software.

The control unit 7 includes signal-input terminals and a microcomputer for processing an image signal input to the signal input terminals and outputs the image signal as an image signal of the inverse image to the display unit 5. To the signal input terminal, input is the image signal of the image, which is to be seen by the driver, including the information from the instruments such as traveling speed, revolution number of the engine, residual amount of the fuel and water temperature in the radiator. Each image signal is generated in an information-generating unit (not shown in the figure) on the basis of the detection by various sensors (not shown in the figure) in the vehicle.

In the following, an operation of the display device for use in a vehicle according to the preferred embodiment will be explained.

When the image to be seen by the driver including the information from the instrument is displayed on the display unit 5, the image light is injected from the flat surface 6b of the correction member 6 and reaches the curved surface 6a passing though the correction member 6. Then, the image light is refracted with a refraction angle corresponding to the curved surface 6a and injected to the windshield 3. In detail, the image light coming out from sections having large refraction angle of the curved surface 6a, such as sections near to the lower periphery 6a2 or right periphery 6a4, is significantly refracted, and then injected to the windshield 3. On the other hand, the image light coming out from sections having small refraction angle of the curved surface 6a, such as section near to the upper periphery 6a1, is not refracted much, and then injected to the windshield 3.

When the coming out image light of the inverse image passes through the opening 1b and injected to the windshield 3, the imaginary virtual image of the inverse image distorted as if the image is pulled in the lower right direction as shown in FIG. 4 is adjusted by the refraction with the curved surface 6a of the correction member 6, that is, the distortion of the virtual image is canceled out. Consequently, when the driver see the windshield 3 in front from the eye point I, the virtual image of the inverse image, the image light of which is reflected on the windshield 3, is a lattice-like image consisting of longitudinal and lateral lines as shown in FIG. 3 without no distortion.

In the preferred embodiment described above, the correction member 6 is formed by extracting from a lens. Instead, the correction member 6 can be used for the display device for use in a vehicle without being extracted from a lens.

FIG. 6A illustrates another preferred embodiment of the correction member, in which a spherical lens 6A as a correction member 6 is arranged above the display unit 5. FIG. 6B illustrates another preferred embodiment of the correction member, in which a cylindrical lens 6B as a correction member 6 is arranged above the display unit 5. In these cases, a spherical lens 6A or a cylindrical lens 6B, having a specific portion corresponding to or similar to the curved surface configuration designed such that the distortion of the inverse image can be canceled out, is selected. The selected lens is arranged so that the specific portion faces the upper surface of the display unit 5. A similar effect to that of the preferred embodiment described above can be obtained with each of these constitutions.

Since the correction member is a specific portion, which can cancel out the distortion of the image, of a spherical lens 6A or a cylindrical lens 6B having a curved surface having a single radius of curvature, even if the shape of the correction member becomes complicated because each correction with different amount thereof is required for corresponding section of the projection area E, there is no need to machine the lens. That is, an existing lens can be used to carry out an accurate correction of the virtual image. Furthermore, even if the shape of the windshield is different depending upon the type of the vehicle and thereby the amount of the correction changes, one can select and use a lens having the specific portion in accordance with the amount of the correction or one can use the specific portion of a lens.

In the preferred embodiment described above, the lens for extracting the correction member 6 therefrom is a flat concave lens. Instead, a biconcave lens or convex lens may be utilized, provided that the distortion of the virtual image can be canceled out.

Further, in the preferred embodiment described above, a lens having the designed curved surface configuration or similar curved surface configuration is selected. Instead, the correction member may be specified from a lens having in advance the specific portion in which the distortion of the virtual image can be canceled out.

What is claimed is:

1. A display device for use in a vehicle, by which an image displayed on a display source is projected on a projection area of a windshield of the vehicle so that the foreground of the vehicle visible from an eye point of the vehicle through the windshield and a virtual image of the image projected on the windshield, which is superposed upon the foreground, are seen together, comprising
a correction member, disposed between the windshield and the display source, for transmitting a light of the image therethrough so as to correct the image to be projected on the windshield so that distortion of the image, which is seen from the eye point, arising from non-plane of the projection area of the windshield is canceled out,
wherein the correction member is formed by extracting a specific portion, which can cancel out the distortion of the image, from a lens having a curved surface having a single radius of curvature.

2. A display device for use in a vehicle, by which an image displayed on a display source is projected on a projection area of a windshield of the vehicle so that the foreground of the vehicle visible from an eye point of the vehicle through the windshield and a virtual image of the image projected on the windshield, which is superposed upon the foreground, are seen together, comprising
a correction member, disposed between the windshield and the display source, for transmitting a light of the image therethrough so as to correct the image to be projected on the windshield so that distortion of the image, which is seen from the eye point, arising from non-plane of the projection area of the windshield is canceled out,
wherein the correction member is a specific portion, which can cancel out the distortion of the image, of a lens having a curved surface having a single radius of curvature.
